(19) United States
(12) Patent Application Publication
(10) Pub. No.: US 2011/0090190 A1
(43) Pub. Date: Apr. 21, 2011

(54) CHARGE SHARING PIXEL STRUCTURE OF DISPLAY PANEL AND METHOD OF DRIVING THE SAME

(76) Inventor: Shu-Yang Lin, Yunlin County (TW)

(21) Appl. No.: 12/637,736

(22) Filed: Dec. 14, 2009

(30) Foreign Application Priority Data
Oct. 15, 2009 (TW) 098134942

(51) Int. Cl. G06F 3/038

(52) U.S. Cl. 345/205

(57) ABSTRACT

A charge sharing pixel structure of a display panel is provided. The charge sharing pixel structure comprises a first pixel, a second pixel, a charge sharing switching element, and a controlled signal line. The charge sharing switching element comprises a first gate electrode, a first source/drain electrode, and a second source/drain electrode. The first source/drain electrode is electrically connected to the first pixel, the second source/drain electrode is electrically connected to the second pixel, and the charge sharing switching element is used to control the electrically connected path between the first pixel and the second pixel. The controlled signal line is electrically connected to the first gate electrode to control the charge sharing switching element.

### BACKGROUND OF THE INVENTION

1. Field of the Invention

The present invention relates to a charge sharing pixel structure of a display panel and a method of driving the same, and more particularly to a charge sharing pixel structure of a display panel which has a charge sharing switching element disposed in each two pixels and a signal control line or a gate line configured to control the charge sharing switching element, and a method of driving the same.

2. Description of the Prior Art

For current liquid crystal display panels, in order to avoid the problem of charge accumulation resulted from the mobile ions in the liquid crystal, the polarity inversion is required to be performed on the voltage across the liquid crystal of each pixel, so that the polarity of the voltage of one frame is contrary to that of the subsequent frame. The common methods of the polarity inversion are frame inversion, row inversion, column inversion, and dot inversion. Other methods are all the transformation of the aforementioned four methods. If a frequency of the polarity inversion is close to a frequency of the response of human eyes, then the flicker of the frame will be noticed. Using the dot inversion can acquire a better frame effect, and is widely applied in the liquid crystal display panels. Please refer to FIGS. 1a and 1b. FIGS. 1a and 1b are schematic diagrams illustrating a dot inversion mechanism in the prior art, wherein FIG. 1a depicts a polarity distribution of pixels in a (N)th frame, and FIG. 1b depicts a polarity distribution of pixels in a (N+1)th frame. As shown in FIGS. 1a and 1b, for the same data line, the polarities of the output voltage in the data line are applied alternately, i.e. positive voltage and negative voltage are alternately applied to the same data line at different time. The power consumption of charging and discharging a liquid crystal capacitor C_{LC} of each pixel is (½)fCLcV², wherein f is a frequency of the charging and discharging, V is the voltage difference of the charging and discharging. In a condition of a fixed f and a fixed C_{LC}, the power consumption will be reduced as decreasing the voltage difference of the charging and discharging.

As a result, the problem of the power consumption can be reduced by decreasing the voltage difference of the charging and discharging. Accordingly, a conventional charge sharing mechanism is integrated into a source driver to reach the demand of reducing the power consumption in the prior art. Please refer to FIG. 2. FIG. 2 is a schematic diagram illustrating a charge sharing mechanism in the prior art. As shown in FIG. 2, in a short time period before outputting a voltage by an output operational amplifier OP of the source driver, a switching element S1 on an odd-numbered data line and a switching element S2 on an even-numbered data line are turned off, while a switching element S3 is turned on to create an electrical connection between the odd-numbered data line and the even-numbered data line. Accordingly, the charge sharing is implemented on the pixels connected to the odd-numbered data line and the even-numbered data line when the gate line is turned on. Consequently, the voltage difference of the charging and discharging is reduced, which therefore can achieve power consumption reduction. However, limitation and disadvantage exist in the prior art because only a small portion of time period in turning on one gate line (lower than one tenth of time period of turning on one gate line) can be utilized to perform the charge sharing, while the rest portion of time period is required to receive the voltage signal from the data lines to charge or discharge the pixel. Therefore, in a limited time period of the charge sharing, there is insufficient time to reach the required voltage level of the charge sharing.

### SUMMARY OF THE INVENTION

It is therefore one of the objectives of the present invention to provide a charge sharing pixel structure of a display panel and a method of driving the same to reduce the limitation and disadvantage in the prior art.

According to the present invention, a charge sharing pixel structure of a display panel is provided. The charge sharing pixel structure of the display panel includes a first pixel, a second pixel, a charge sharing switching element, and a signal control line. The charge sharing switching element has a first gate electrode, a first source/drain electrode, and a second source/drain electrode, wherein the first source/drain electrode is electrically connected to the first pixel, the second source/drain electrode is electrically connected to the second pixel, and the charge sharing switching element is configured to switch an electrical connection between the first pixel and the second pixel. The signal control line is electrically connected to the first gate electrode, and the signal control line is configured to control a switching of the charge sharing switching element.

According to the present invention, a method of driving a charge sharing pixel structure of a display panel is provided. The method includes the following steps. First, a pixel structure is provided. The pixel structure includes a first pixel, a second pixel, a charge sharing switching element, and a signal control line. The first pixel has a first voltage, the second pixel has a second voltage, and the first voltage is different from the second voltage. The charge sharing switching element has a first gate electrode, a first source/drain electrode, and a second source/drain electrode, wherein the first source/drain electrode is electrically connected to the first pixel, the second source/drain electrode is electrically connected to the second pixel, and the charge sharing switching element is configured to switch an electrical connection between the first pixel and the second pixel. The signal control line is electrically connected to the first gate electrode, and the signal control line is configured to control a switching of the charge sharing switching element. Then, the signal control line is configured to transmit a control signal to turn on the charge sharing switching element to implement a charge sharing between the first pixel and the second pixel. Subsequently, a first data signal is transmitted to the first pixel to render the first pixel have a third voltage, and a second data signal is transmitted to the second pixel to render the second pixel have a fourth voltage.

According to the present invention, a charge sharing display panel is provided. The charge sharing display panel includes M gate lines, N data line units, and a pixel array. The M gate lines are substantially arranged in parallel with each other, and the M gate lines are configured to respectively transmit first-(M)th gate signals, wherein M is an integer. The N data line units are substantially arranged in parallel with each other and perpendicular to the M gate lines, wherein N is an integer. Each of the N data line units includes a first data line and a second data line, the first data line is configured to transmit a first data signal, and the second data line is configured to transmit a second data signal. The pixel array has pixel units with M rows and N columns, and each pixel unit is disposed at a side of each corresponding gate line. Each pixel unit includes a first pixel, a second pixel, a charge sharing switching element, a first pixel switching element, and a second pixel switching element. The charge sharing switching element has a first gate electrode, a first source/drain electrode, and a second source/drain electrode, wherein the first source/drain electrode is electrically connected to the first pixel, the second source/drain electrode is electrically connected to the second pixel, and the charge sharing switching element is configured to switch an electrical connection between the first pixel and the second pixel. The first pixel switching element has a second gate electrode, a third source/drain electrode, and a fourth source/drain electrode, wherein the third source/drain electrode is electrically connected to the first pixel, the fourth source/drain electrode is configured to receive the first data signal, and the first pixel switching element is configured to switch a transmission channel of the first data signal. The second pixel switching element has a third gate electrode, a fifth source/drain electrode, and a sixth source/drain electrode, wherein the fifth source/drain electrode is electrically connected to the second pixel, the sixth source/drain electrode is configured to receive the second data signal, and the second pixel switching element is configured to switch a transmission channel of the second data signal. A (P)th gate line is electrically connected to the second gate electrode and the third gate electrode of each pixel unit of a (P)th row, the (P)th gate line is electrically connected to the first gate electrode of the charge sharing switching element of each pixel unit of a (P+1)th row, P is an integer between 1 and (M−1), and a (M)th gate line is electrically connected to the second gate electrode and the third gate electrode of each pixel unit of a (M)th row.

According to the present invention, a method of driving a charge sharing display panel is provided. The method includes the following steps. First, a display panel is provided. The display panel includes M gate lines, N data line units, and a pixel array. The M gate lines are substantially arranged in parallel with each other, and the M gate lines are configured to respectively transmit first-(M)th gate signals, wherein M is an integer. The N data line units are substantially arranged in parallel with each other and perpendicular to the M gate lines, wherein N is an integer. Each of the N data line units includes a first data line and a second data line, the first data line is configured to transmit a first data signal, and the second data line is configured to transmit a second data signal. The pixel array has pixel units with M rows and N columns, and each pixel unit is disposed at a side of each corresponding gate line. Each pixel unit includes a first pixel, a second pixel, a charge sharing switching element, a first pixel switching element, and a second pixel switching element. The first pixel has a first voltage, the second pixel has a second voltage, and the first voltage is different from the second voltage. The charge sharing switching element has a first gate electrode, a first source/drain electrode, and a second source/drain electrode, wherein the first source/drain electrode is electrically connected to the first pixel, the second source/drain electrode is electrically connected to the second pixel, and the charge sharing switching element is configured to switch an electrical connection between the first pixel and the second pixel. The first pixel switching element has a second gate electrode, a third source/drain electrode, and a fourth source/drain electrode, wherein the third source/drain electrode is electrically connected to the first pixel, the fourth source/drain electrode is configured to receive the first data signal, and the first pixel switching element is configured to switch a transmission channel of the first data signal. The second pixel switching element has a third gate electrode, a fifth source/drain electrode, and a sixth source/drain electrode, wherein the fifth source/drain electrode is electrically connected to the second pixel, the sixth source/drain electrode is configured to receive the second data signal, and the second pixel switching element is configured to switch a transmission channel of the second data signal. A (P)th gate line is electrically connected to the second gate electrode and the third gate electrode of each pixel unit of a (P)th row, the (P)th gate line is electrically connected to the first gate electrode of the charge sharing switching element of each pixel unit of a (P+1)th row, P is an integer between 1 and (M−1), and a (M)th gate line is electrically connected to the second gate electrode and the third gate electrode of each pixel unit of a (M)th row. Subsequently, a charge sharing step is performed, by utilizing the (P)th gate line to transmit a (P)th gate signal to the third gate electrode of the charge sharing switching element of each pixel unit of the (P+1)th row to implement a charge sharing between the first pixel and the second pixel of each pixel unit. Following that, a signal input step is performed, by utilizing the (P+1)th gate line to transmit a (P+1)th gate signal to the first gate electrode and the second gate electrode of each pixel unit of the (P+1)th row, utilizing the first data line of a (S)th data line unit to transmit the first data signal to the first pixel of each pixel unit of a (S)th column to render the first pixel have a third voltage, and utilizing the second data line of the (S)th data line unit to transmit the second data signal to the second pixel of each pixel unit of the (S)th column to render the second pixel have a fourth voltage, wherein S is an integer between 1 and N.

In the charge sharing pixel structure of the display panel and the method of driving the same of the present invention, a charge sharing switching element is installed in each two pixels, and the charge sharing switching element is controlled by a signal control line or a gate line. Accordingly, it not only has advantages of discharging in advance and reducing power consumption but also provides more charge sharing time than that in the prior art. In addition, about the methods of polarity inversion, the present invention can be suitable for dot inversion, column inversion, or other kinds of polarity inversion with the first pixel and the second pixel of each pixel unit of each row having different voltages. As a result, the application range of the present invention can be increased.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1a and 1b are schematic diagrams illustrating a dot inversion mechanism in the prior art.

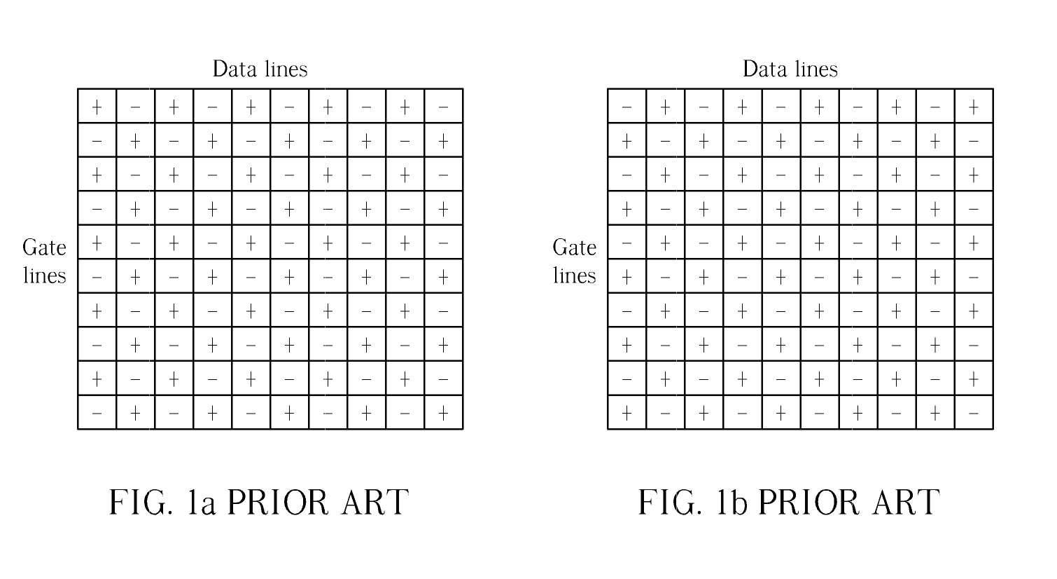

FIG. 2 is a schematic diagram illustrating a charge sharing mechanism in the prior art.

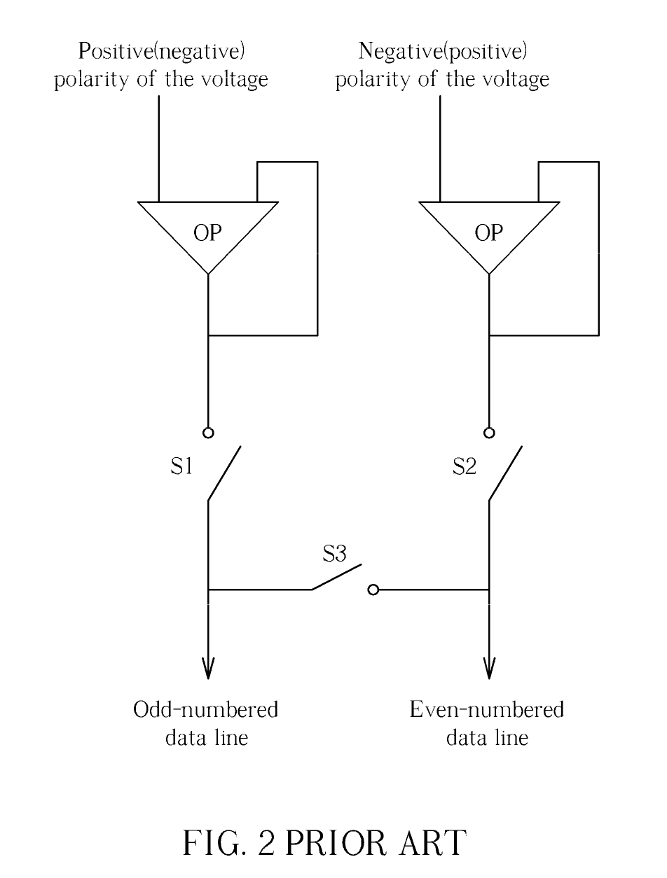

FIG. 3 is a schematic diagram illustrating a charge sharing pixel structure of a display panel according to a preferred embodiment of the present invention.

FIG. 4 is a schematic diagram illustrating a pixel unit in FIG. 3.

FIG. 5 is a flowchart illustrating a method of driving a charge sharing pixel structure of a display panel according to a preferred embodiment of the present invention.

FIG. 6 is a partial timing diagram illustrating driving voltages of a charge sharing pixel structure of a display panel according to a preferred embodiment of the present invention.

### DETAILED DESCRIPTION

In the following specifications and claims, certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to”. Also, the term “electrically connect” is intended to mean either an indirect or direct electrical connection. Accordingly, if one device is coupled to another device, that connection may be through a direct electrical connection, or through an indirect electrical connection via other devices and connections.

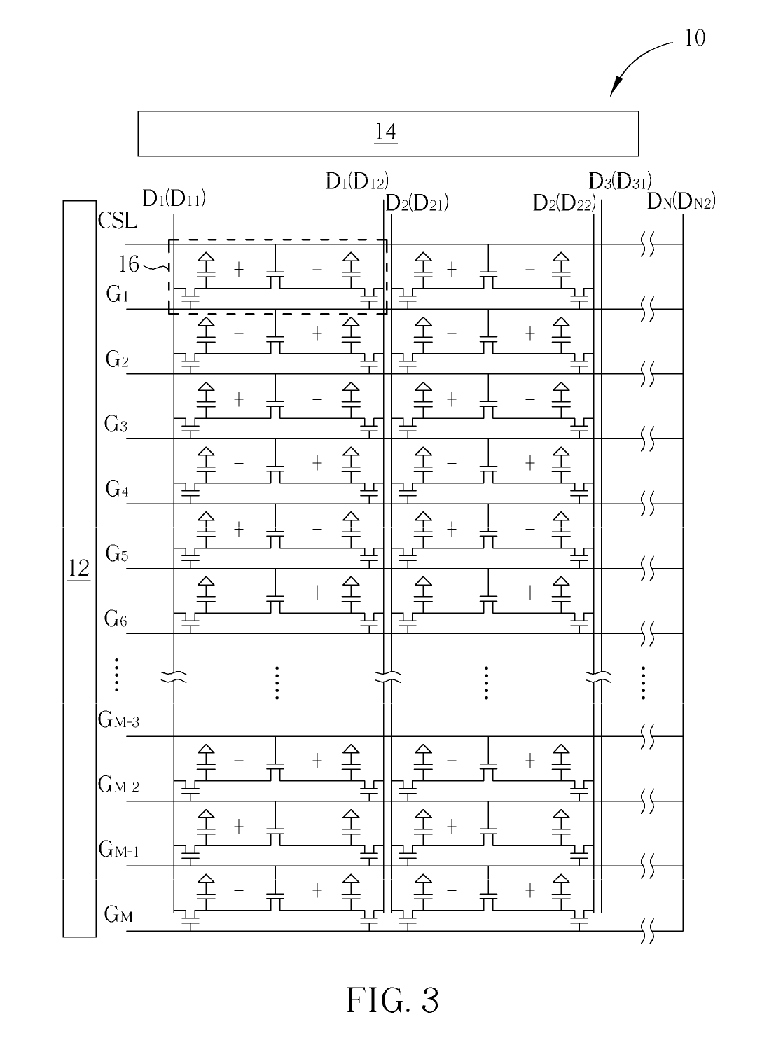

Please refer to FIG. 3. FIG. 3 is a schematic diagram illustrating a charge sharing pixel structure of a display panel according to a preferred embodiment of the present invention, wherein the same component or the same region is indicated as the same symbol. It should be noted that the diagrams are for explanations and are not drawn as original sizes or to scale. As shown in FIG. 3, the display panel 10 of the present embodiment includes a gate driver 12, a source driver 14, M gate lines G₁˜G_{M} arranged substantially in parallel with each other, a signal control line CSL, N data line units D₁˜D_{N} arranged substantially in parallel with each other, and a pixel array composed with a plurality of pixel units 16, wherein M, N are integers, In the present embodiment, the gate driver 12 is configured to drive the M gate lines G₁˜G_{M}, so that the M gate lines respectively transmit first-(M)th gate signals. The source driver 14 is configured to drive N data line units D₁˜D_{N}. Take the data line units D₁ as an example, the data line units D₁ includes a first data line D₁₁ and a second data line D₁₂. The first data line D₁₁ is configured to transmit a first data signal, and the second data line D₁₂ is configured to transmit a second data signal. The pixel array has pixel units 16 with M rows and N columns, and each pixel unit 16 is disposed at a side of each corresponding gate line. In addition, a distance between each data line is not required to be the same. In the present embodiment, a distance between the second data lines D₁₂ and the first data lines D₂₁ is shorter than a distance between the first data lines D₁₁ and the second data lines D₁₂, but it is not limited herein.

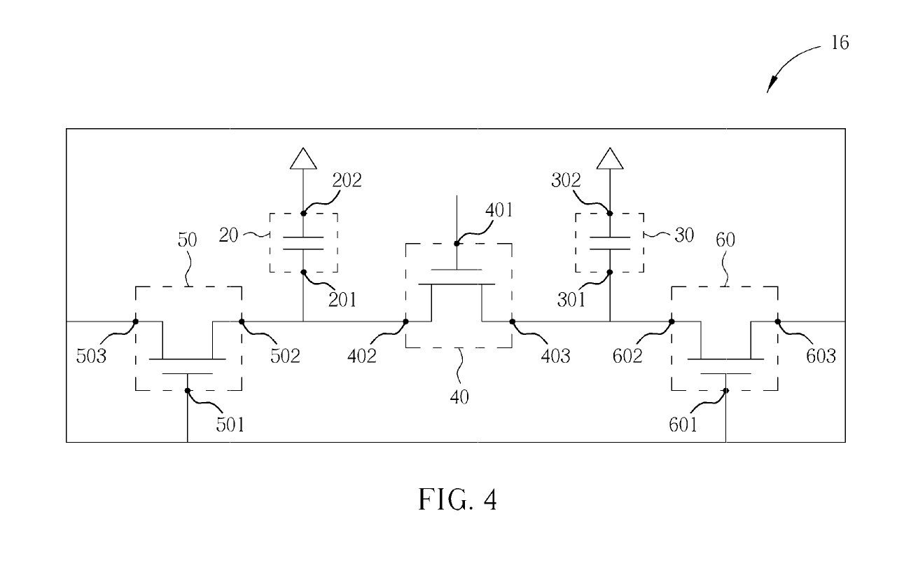

Please refer to FIG. 4 in combination with FIG. 3. FIG. 4 is a schematic diagram illustrating a pixel unit 16 in FIG. 3. As shown in FIG. 4, the pixel unit 16 includes a first pixel 20, a second pixel 30, a charge sharing switching element 40, a first pixel switching element 50, and a second pixel switching element 60. The charge sharing switching element 40 has a first gate electrode 401, a first source/drain electrode 402, and a second source/drain electrode 403, wherein the first source/drain electrode 402 is electrically connected to the first pixel 20, the second source/drain electrode 403 is electrically connected to the second pixel 30, and the charge sharing switching element 40 is configured to switch an electrical connection between the first pixel 20 and the second pixel 30. The first pixel switching element 50 has a second gate electrode 501, a third source/drain electrode 502, and a fourth source/drain electrode 503, wherein the third source/drain electrode 502 is electrically connected to the first pixel 20, the fourth source/drain electrode 503 is configured to receive the first data signal, and the first pixel switching element 50 is configured to switch a transmission channel of the first data signal. The second pixel switching element 60 has a third gate electrode 601, a fifth source/drain electrode 602, and a sixth source/drain electrode 603, wherein the fifth source/drain electrode 602 is electrically connected to the second pixel 30, the sixth source/drain electrode 603 is configured to receive the second data signal, and the second pixel switching element 60 is configured to switch a transmission channel of the second data signal. It should be noted that the first pixel 20 includes a pixel electrode 201, a common electrode 202, and a liquid crystal between the pixel electrode 201 and the common electrode 202. Also, the second pixel 30 includes a pixel electrode 301, a common electrode 302, and a liquid crystal between the pixel electrode 301 and the common electrode 302. In this document, being electrically connected to the first pixel 20 means being electrically connected to the pixel electrode 201, and being electrically connected to the first pixel 30 means being electrically connected to the pixel electrode 301.

A connection relation between each pixel unit and other lines is explained as follows. Please refer to FIGS. 3 and 4 again. First, take the pixel unit 16 of the first row and first column of the pixel array as an example. The signal control line CSL is electrically connected to the first gate electrode 401 of the charge sharing switching element 40, and the signal control line CSL is configured to control a switching of the charge sharing switching element 40. The first data line D₁₁ is electrically connected to the fourth source/drain electrode 503 of the first pixel switching element 50, and the first data line D₁₁ is configured to transmit a first data signal. The second data line D12 is electrically connected to the sixth source/drain electrode 603 of the second pixel switching element 60, and the second data line D₁₂ is configured to transmit a second data signal. Then, take each pixel unit 16 of a (P)th row as an example, wherein P is an integer between 1 and (M−1). A (P)th gate line is electrically connected to the second gate electrode 501 and the third gate electrode 601 of each pixel unit 16 of the (P)th row, the (P)th gate line is electrically connected to the first gate electrode 401 of the charge sharing switching element 40 of each pixel unit 16 of a (P+1)th row, and a (M)th gate line is electrically connected to the second gate electrode 501 and the third gate electrode 601 of each pixel unit 16 of a (M)th row. It should be noted that, for the display panel 10, the signal control line CSL of the present embodiment is not required to exist. In other words, without the signal control line CSL only results in no charge sharing in the pixel units of the first row, and the charge sharing still can be implanted on the pixel units of other rows by the gate lines. Furthermore, in the present embodiment, the signal control line CSL can be electrically connected to the (M)th gate line. In other words, the gate driver 12 can provide the same signal to both of the signal control line CSL and the (M)th gate line, but it is not limited herein.

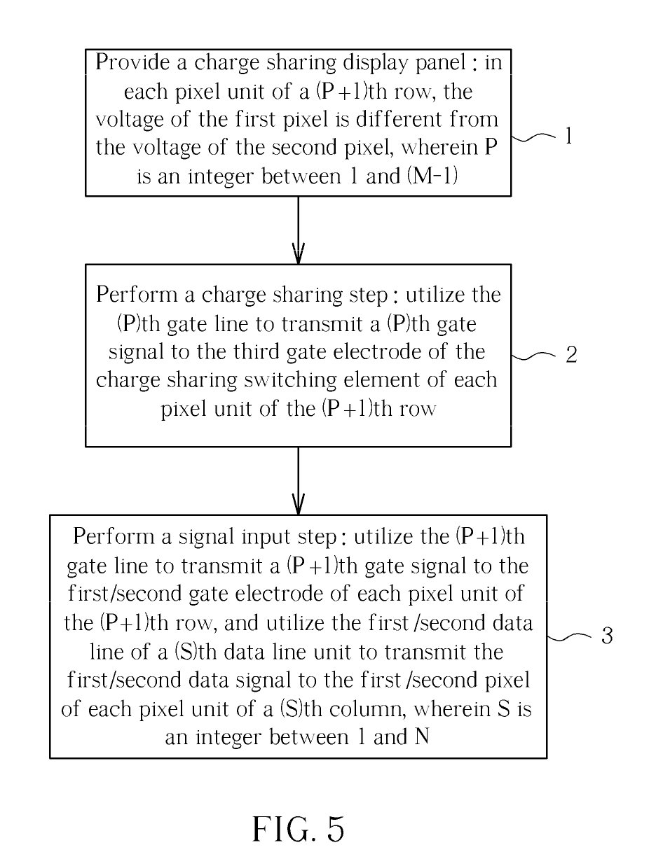

A method of driving a charge sharing pixel structure of a display panel is explained as follows. Please refer to FIG. 5 and in combination with FIGS. 3 and 4. FIG. 5 is a flowchart illustrating a method of driving a charge sharing pixel structure of a display panel according to a preferred embodiment of the present invention. Take the method of driving each pixel unit of the (P+1)th row as an example, wherein P is an integer between 1 and (M−1). As shown in FIG. 5, step 1 is first performed by providing a display panel 10 (as shown in FIG. 3), wherein the configuration of the display panel 10 is as described previously, and it will not repeat herein. Also, in each pixel unit of the (P+1)th row, the first pixel has a first voltage, the second pixel has a second voltage, and the first voltage is different from the second voltage. In the present embodiment, the method of the polarity inversion of the display panel 10 is dot inversion. As shown in FIG. 3, the polarities of two adjacent pixels are different. But it is not limited herein. The display panel 10 of the present embodiment can be suitable for column inversion, or other kinds of polarity inversion with the first pixel and the second pixel of each pixel unit of each row having different voltages.

Then, as shown in FIG. 5, step 2 which includes the following steps is performed. Perform a charge sharing step on each pixel unit of a (P+1)th row: utilize the (P)th gate line to transmit a (P)th gate signal to the third gate electrode of the charge sharing switching element of each pixel unit of the (P+1)th row for performing a charge sharing between the first pixel and the second pixel of each pixel unit. Subsequently, step 3 which includes the following steps is performed. Perform a signal input step on each pixel unit of the (P+1)th row: utilize the (P+1)th gate line to transmit a (P+1)th gate signal to the first gate electrode and the second gate electrode of each pixel unit of the (P+1)th row, simultaneously utilize the first data line of a (S)th data line unit to transmit the first data signal to the first pixel of each pixel unit of a (S)th column for letting the first pixel have a third voltage, and simultaneously utilize the second data line of a (S)th data line unit to transmit the second data signal to the second pixel of each pixel unit of a (S)th column for letting the second pixel have a fourth voltage, wherein S is an integer between 1 and N. In the present embodiment, the third voltage is the same with the second voltage, and the fourth voltage is the same with the first voltage, i.e. to exchange the voltages between the first pixel and the second pixel, but it is not limited herein.

It should be noted that, in the method of driving each pixel unit of the (P+1)th row, the charge sharing step of each pixel unit of the (P+1)th row can be simultaneously performed with the signal input step of each pixel unit of the (P)th row. In other words, when the signal input step is performed on each pixel unit of the (P)th row, the charge sharing step can be performed on each pixel unit of the (P+1)th row in advance. Accordingly, without increasing an additional time, it can utilize the time period of the signal input step on each pixel unit of the (P)th row to perform the charge sharing step on each pixel unit of the (P+1)th row, so that it has the time period of one gate line being turned on to implant the charge sharing. As a result, the present embodiment has enough time to sufficiently reach the required voltage level of the charge sharing.

In addition, the case about each pixel unit of the first row is not explained in FIG. 5 for two reasons. One reason is that the charge sharing can be not performed on each pixel unit of the first row, and the other reason is to avoid the confusion on explain of the explanation. About the method of driving each pixel unit of the first row will be explained as follows. The steps are substantially the same with that in FIG. 5, and only the difference is explained as follows. First, in the step 1, the display panel is required to have a signal control line CSL. Then, in the step 2, the signal control line CSL is configured to control the charge sharing of each pixel unit of the first row. Subsequently, in the step 3, the signal input step is performed on each pixel unit of the first row: utilize the first gate line to transmit a first gate signal to the first gate electrode and the second gate electrode of each pixel unit of the first row, simultaneously utilize the first data line of a (S)th data line unit to transmit the first data signal to the first pixel of each pixel unit of a (S)th column of the first row, and simultaneously utilize the second data line of a (S)th data line unit to transmit the second data signal to the second pixel of each pixel unit of a (S)th column of the first row. It should be noted that the signal control line can have the same signal with the (M)th gate line. In other words, when the signal input step is performed on each pixel unit of the (M)th row, the charge sharing step can be performed on each pixel unit of the first row in advance, so that it has enough time for the charge sharing.

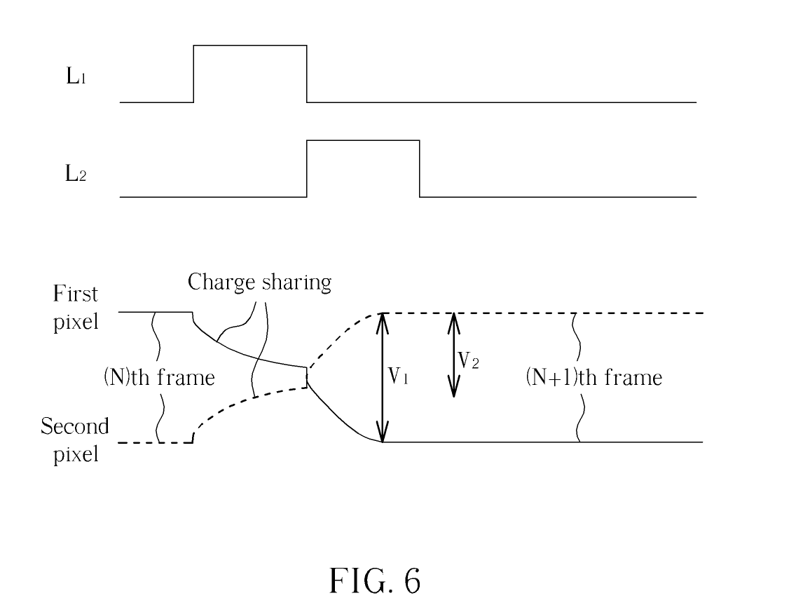

In order to further explain the operation principle of the present invention, FIG. 6 is a partial timing diagram illustrating driving voltages of a charge sharing pixel structure of a display panel according to a preferred embodiment of the present invention. As shown in FIG. 6, a signal line L1 is configured to control the charge sharing switching element, and a signal line L2 is configured to control the pixel switching element. In the present embodiment, it has different conditions for different rows. For example, for each pixel unit of the first row, the signal line L1 can be the signal control line CSL, and the signal line L2 can be the first gate line. Or, for each pixel unit of the (P+1)th row, the signal line L1 can be the (P)th gate line, and the signal line L2 can be the (P+1)th gate line, wherein P is an integer between 1 and (M−1). As shown in FIG. 6, for the second pixel, without the mechanism of the charge sharing, the voltage difference for the charging may be a voltage difference V₁. With the mechanism of the charge sharing, the voltage difference for the charging may be reduced to a voltage difference V₂. Therefore, in the present invention, the starting voltage for the charging is more close to the required voltage, so that the power consumption of the charging and discharging can be effectively reduced.

In conclusion, in the charge sharing pixel structure of the display panel and the method of driving the same of the present invention, a charge sharing switching element is added in each two pixels, and the charge sharing switching element is controlled by a signal control line or a gate line. Accordingly, it not only has advantages of discharging in advance and reducing power consumption but also provides more charge sharing time than that in the prior art. In addition, without increasing an additional time, it can utilize the time period of the signal input step on each pixel unit of one row to perform the charge sharing step on each pixel unit of an adjacent row, so that it has the time period of one gate line being turned on to implant the charge sharing and the time period for the charge sharing is more than that in the prior art. Accordingly, the present embodiment has enough time to sufficiently reach the required voltage level of the charge sharing. Furthermore, about the methods of polarity inversion, the present invention can be suitable for dot inversion, column inversion, or other kinds of polarity inversion with the first pixel and the second pixel of each pixel unit of each row having different voltages. As a result, the application range of the present invention can be increased.

Those skilled in the art will readily observe that numerous modifications and alterations of the device and method may be made while retaining the teachings of the invention.

What is claimed is:

1. A charge sharing pixel structure of a display panel, comprising:
a first pixel and a second pixel;
a charge sharing switching element, the charge sharing switching element having a first gate electrode, a first source/drain electrode, and a second source/drain electrode, wherein the first source/drain electrode is electrically connected to the first pixel, the second source/drain electrode is electrically connected to the second pixel, and the charge sharing switching element is configured to switch an electrical connection between the first pixel and the second pixel; and
a signal control line, electrically connected to the first gate electrode, the signal control line being configured to control a switching of the charge sharing switching element.

2. The charge sharing pixel structure of the display panel of claim 1, further comprising a first pixel switching element, the first pixel switching element having a second gate electrode, a third source/drain electrode, and a fourth source/drain electrode, wherein the third source/drain electrode is electrically connected to the first pixel, the fourth source/drain electrode is configured to receive a first data signal, and the first pixel switching element is configured to switch a transmission channel of the first data signal.

3. The charge sharing pixel structure of the display panel of claim 2, further comprising a second pixel switching element, the second pixel switching element having a third gate electrode, a fifth source/drain electrode, and a sixth source/drain electrode, wherein the fifth source/drain electrode is electrically connected to the second pixel, the sixth source/drain electrode is configured to receive a second data signal, and the second pixel switching element is configured to switch a transmission channel of the second data signal.

4. The charge sharing pixel structure of the display panel of claim 3, further comprising a gate line, wherein the gate line is electrically connected to the second gate electrode and the third gate electrode, and the gate line is configured to control a switching of the first pixel switching element and a switching of the second pixel switching element.

5. The charge sharing pixel structure of the display panel of claim 4, further comprising a first data line, wherein the first data line is electrically connected to the fourth source/drain electrode, and the first data line is configured to transmit the first data signal.

6. The charge sharing pixel structure of the display panel of claim 5, further comprising a second data line, wherein the second data line is electrically connected to the sixth source/drain electrode, and the second data line is configured to transmit the second data signal.

7. A method of driving a charge sharing pixel structure of a display panel, comprising:
providing a pixel structure, the pixel structure comprising:
a first pixel and a second pixel, wherein the first pixel has a first voltage, the second pixel has a second voltage, and the first voltage is different from the second voltage;
a charge sharing switching element, and the charge sharing switching element having a first gate electrode, a first source/drain electrode, and a second source/drain electrode, wherein the first source/drain electrode is electrically connected to the first pixel, the second source/drain electrode is electrically connected to the second pixel, and the charge sharing switching element is configured to switch an electrical connection between the first pixel and the second pixel; and
a signal control line, electrically connected to the first gate electrode, and the signal control line being configured to control a switching of the charge sharing switching element;
utilizing the signal control line to transmit a control signal to turn on the charge sharing switching element to implement a charge sharing between the first pixel and the second pixel; and
transmitting a first data signal to the first pixel to render the first pixel have a third voltage, and transmitting a second data signal to the second pixel to render the second pixel have a fourth voltage.

8. A charge sharing display panel, comprising:
M gate lines, substantially arranged in parallel with each other, the M gate lines being configured to respectively transmit first-(M)th gate signals, wherein M is an integer;
N data line units, substantially arranged in parallel with each other and perpendicular to the M gate lines, wherein N is an integer, each of the N data line units comprises a first data line and a second data line, the first data line is configured to transmit a first data signal, and the second data line is configured to transmit a second data signal; and
a pixel array having pixel units with M rows and N columns, each pixel unit being disposed at a side of each corresponding gate line, and each pixel unit comprising:
a first pixel and a second pixel;
a charge sharing switching element, and the charge sharing switching element having a first gate electrode, a first source/drain electrode, and a second source/drain electrode, wherein the first source/drain electrode is electrically connected to the first pixel, the second source/drain electrode is electrically connected to the second pixel, and the charge sharing switching element is configured to switch an electrical connection between the first pixel and the second pixel;
a first pixel switching element, the first pixel switching element having a second gate electrode, a third source/drain electrode, and a fourth source/drain electrode, wherein the third source/drain electrode is electrically connected to the first pixel, the fourth source/drain electrode is configured to receive the first data signal, and the first pixel switching element is configured to switch a transmission channel of the first data signal; and
a second pixel switching element, the second pixel switching element having a third gate electrode, a fifth source/drain electrode, and a sixth source/drain electrode, wherein the fifth source/drain electrode is electrically connected to the second pixel, the sixth source/drain electrode is configured to receive the second data signal, and the second pixel switching element is configured to switch a transmission channel of the second data signal;
wherein, a (P)th gate line is electrically connected to the second gate electrode and the third gate electrode of each pixel unit of a (P)th row, the (P)th gate line is electrically connected to the first gate electrode of the charge sharing switching element of each pixel unit of a (P+1)th row, P is an integer between 1 and (M−1), and a (M)th gate line is electrically connected to the second gate electrode and the third gate electrode of each pixel unit of a (M)th row.

9. The charge sharing display panel of claim 8, further comprising a signal control line, wherein the signal control line is electrically connected to the first gate electrode of the charge sharing switching element of each pixel unit of a first row, and the signal control line is configured to control a switching of the charging sharing switching element.

10. The charge sharing display panel of claim 9, wherein the signal control line is electrically connected to the (M)th gate line.

11. A method of driving a charge sharing display panel, comprising:
providing a display panel, the display panel comprising:
M gate lines, substantially arranged in parallel with each other, the M gate lines being configured to respectively transmit first-(M)th gate signals, wherein M is an integer;
N data line units, substantially arranged in parallel with each other and perpendicular to the M gate lines, wherein N is an integer, each of the data line units comprises a first data line and a second data line, the first data line is configured to transmit a first data signal, and the second data line is configured to transmit a second data signal; and
a pixel array having pixel units with M rows and N columns, each pixel unit being disposed at a side of each corresponding gate line, and each pixel unit comprising:
a first pixel and a second pixel, wherein the first pixel has a first voltage, the second pixel has a second voltage, and the first voltage is different from the second voltage;
a charge sharing switching element, and the charge sharing switching element having a first gate electrode, a first source/drain electrode, and a second source/drain electrode, wherein the first source/drain electrode is electrically connected to the first pixel, the second source/drain electrode is electrically connected to the second pixel, and the charge sharing switching element is configured to switch an electrical connection between the first pixel and the second pixel;
a first pixel switching element, and the first pixel switching element having a second gate electrode, a third source/drain electrode, and a fourth source/drain electrode, wherein the third source/drain electrode is electrically connected to the first pixel, the fourth source/drain electrode is configured to receive the first data signal, and the first pixel switching element is configured to switch a transmission channel of the first data signal; and
a second pixel switching element, and the second pixel switching element having a third gate electrode, a fifth source/drain electrode, and a sixth source/drain electrode, wherein the fifth source/drain electrode is electrically connected to the second pixel, the sixth source/drain electrode is configured to receive the second data signal, and the second pixel switching element is configured to switch a transmission channel of the second data signal;
wherein, a (P)th gate line is electrically connected to the second gate electrode and the third gate electrode of each pixel unit of a (P)th row, the (P)th gate line is electrically connected to the first gate electrode of the charge sharing switching element of each pixel unit of a (P+1)th row, P is an integer between 1 and (M−1), and a (M)th gate line is electrically connected to the second gate electrode and the third gate electrode of each pixel unit of a (M)th row;
performing a charge sharing step, by utilizing the (P)th gate line to transmit a (P)th gate signal to the third gate electrode of the charge sharing switching element of each pixel unit of the (P+1)th row to implement a charge sharing between the first pixel and the second pixel of each pixel unit; and
performing a signal input step, by utilizing the (P+1)th gate line to transmit a (P+1)th gate signal to the first gate electrode and the second gate electrode of each pixel unit of the (P+1)th row, utilizing the first data line of a (S)th data line unit to transmit the first data signal to the first pixel of each pixel unit of a (S)th column to render the first pixel have a third voltage, and utilizing the second data line of the (S)th data line unit to transmit the second data signal to the second pixel of each pixel unit of the (S)th column to render the second pixel have a fourth voltage, wherein S is an integer between 1 and N.

12. The method of claim 11, wherein the charge sharing step of each pixel unit of the (P+1)th row and the signal input step of each pixel unit of the (P)th row are performed at the same time.

13. The method of claim 11, wherein the pixel structure further comprises a signal control line to transmit a control signal to the first gate electrode of the charge sharing switching element of each pixel unit of the first row to control a switching of the charge sharing switching element.

14. The method of claim 13, wherein a signal of the signal control line is the same with a signal of the (M)th gate line.
